(19) United States
(12) Patent Application Publication
(10) Pub. No.: US 2016/0378910 A1
(43) Pub. Date: Dec. 29, 2016

(54) MOLECULAR ACTIVE CENTER IDENTIFICATION USING TUNNELING BARRIERS AND/OR ASSOCIATED MEASUREMENTS FOR SUB-MOLECULAR QSAR

(71) Applicant: Florida Institute of Technology, Inc., Melbourne, FL (US)

(72) Inventors: Joel Olson, Melbourne, FL (US); Mark Novak, Rapid City, SD (US); Clayton Baum, Melbourne, FL (US); Raymond Terryn, Melbourne, FL (US); Krishnan Sriraman, Bangalore (IN)

(73) Assignee: Florida Institute of Technology, Inc., Melbourne, FL (US)

(21) Appl. No.: 15/194,115

(22) Filed: Jun. 27, 2016

Related U.S. Application Data
(60) Provisional application No. 62/184,457, filed on Jun. 25, 2015.

(51) Int. Cl. G06F 19/12; G06F 19/16; G06F 19/00

(52) U.S. Cl. CPC G06F 19/12; G06F 19/701; G06F 19/16

(57) ABSTRACT

A novel computational QSAR approach that provides sub-molecular correlations that are specific to individual lobes of the pertinent molecular orbitals.

### CROSS REFERENCE TO RELATED APPLICATIONS

This application claims the benefit of U.S. Provisional Application No. 62/184,457 entitled “MOLECULAR ACTIVE CENTER IDENTIFICATION USING TUNNELING BARRIERS FOR SUB-MOLECULAR QSAR” filed Jun. 25, 2015, which is hereby incorporated by reference in its entirety.

### STATEMENT REGARDING FEDERALLY SPONSORED RESEARCH OR DEVELOPMENT

This invention was made with government support under Grant #1058427 awarded by the National Science Foundation. The government has certain rights in the invention.

### INCORPORATION-BY-REFERENCE OF MATERIAL SUBMITTED ON A COMPACT DISK

Not applicable.

### FIELD OF INVENTION

The present disclosure generally relates to the use of sub-molecular quantitative structure-activity relationships (“QSAR”) to determine biological (or other chemical) activity of a molecule and more particularly to the use of computational electron tunneling barriers and other related measurements, such as dI/dz, as more particularly described herein, to determine specific locations within a set of molecular species where a chemical event, dependent on the tunneling, must occur.

### BACKGROUND

A key element in the development of new therapeutic agents is an understanding of how specific compounds interact with biological systems at the molecular level. More specifically, knowing what portion(s) of a molecule confers either therapeutic or toxic effects can greatly facilitate lead optimization and design of second-generation analogues. Current methods for identifying a molecule's pharmacophore usually rely on quantitative structure activity relationship (QSAR) studies whereby the in vitro and/or in vivo activities of a series of analogues are correlated with specific physical properties derived experimentally.

This work proposes the application of scanning tunneling microscopy (STM) and scanning tunneling spectroscopy (STS), in combination with density functional theory (DFT) to improve the ability to identify pharmacophores. More specifically, we report initial results from the recent development of a novel, high-level, sub-molecular quantum computational descriptor for quantitative structure-activity relationship (QSAR) analyses that has been applied for the first time to a biochemically relevant scenario. The descriptor allows for multiple, regio specific training sets to be simultaneously constructed to aid in identification of the active center(s) of small molecule drug candidates. As such, this sub molecular tunneling analysis of barriers, or STAB methodology is being developed in order to refine current predictive models involved in early stage drug development.

In addition, there exists a wealth of patent data on the efficacy of these compounds toward killing various pathogenic organisms from which QSAR data can be derived. Although attempts have been made at QSAR to correlate structure with in vitro IC₅₀s, the above factors, combined with a dearth of information regarding tryptanthrins' mechanisms of action, provides us with a relevant scenario in which to test our approach.

In keeping with our specific interests in elucidating tryptanthrins' mechanisms of action against neglected tropical diseases, we initiated multiple lines of inquiry utilizing both predictive modeling in combination with reported experimental data in order to refine and re-examine earlier attempts to generate QSAR data of tryptantrin activities against Plasmodium falciparum, the strain of malaria that tends to be fatal to humans if left untreated.

### SUMMARY

A method of determining the location on a molecule that is of greatest importance to the activity of that molecule comprises identifying and isolating the locations of molecular orbitals on a molecule, using a mathematical function to model the molecule's electron state interactions with other atoms or molecules, calculating the decay of each interaction along a specified direction and plotting the decay of interaction against the efficacy of the molecule to generate a sub-molecular quantitative structure-activity relationship training set to observe any correlation, wherein the higher correlation corresponds to a molecular orbital location that is critical for the function of that molecule.

The method can include identifying and isolating the locations of molecular orbitals on a molecule by constructing a computer model of the molecular analog to be tested, calculating multiple iso-values of at least one molecular orbital for the model, and using the iso-values to construct a three-dimensional matrix for said at least one molecular orbital.

The method can include using a mathematical function to model the molecule's electron state interactions with other atoms or molecules by using a three-dimensional probe function matrix, performing a three-dimensional convolution of the probe matrix and said at least one molecular orbital thereby yielding an overlap matrix, and determining a two-dimensional topography iso-surface in a selected x, y plane from the overlap matrix thereby calculating at least one x,y location.

The method can include calculating the decay of each interaction along a specified direction further by determining a z-direction decay of the overlap matrix for each x,y location of said topography iso-surface.

The method can include plotting the decay of interaction by plotting the decay or topography iso-surface in two dimensions for each x,y location thereby yielding an analytical image comprised of pixels, locating each molecular orbital lobe in the analytical image and evaluating the pixel quantities associated therewith; and for each molecular orbital lobe, plotting the efficacy against evaluated pixel quantities for multiple molecular analogs.

A method of determining the location on a molecule that is of greatest importance to the activity of that molecule comprises identifying and isolating the locations of molecular orbitals on a molecule, using a mathematical function to model the molecule's electron state interactions with other atoms or molecules, calculating the related electron energy barrier of each interaction along a specified direction and plotting the related electron energy barrier of the interaction against the efficacy of the molecule to generate a sub-molecular quantitative structure-activity relationship training set to observe any correlation, wherein the higher correlation corresponds to a molecular orbital location that is critical for the function of that molecule.

The method can include calculating molecular orbitals using density functional theory or by a Hatree-Fock method.

The method can further include constructing a probe function matrix using at least one of the functions selected from the group consisting of a spherical Gaussian function, a spherical exponential function, an atomic orbital function, a molecular structure function, and a probe molecular orbital function.

The method can further include determining z-direction decay using at least one of the decay functions selected from the group consisting of exponential decay function, Gaussian decay function, Lorentzian decay function, polynomial decay function and linear decay function.

The method can include evaluating the pixel quantities by at least one method selected from the group consisting of summing, averaging the median, maximum or minimum over the lobe, individual pixel evaluation, and multiple pixel evaluation.

The method can include plotting efficacy using at least one of the methods selected from the group consisting of linear plotting and logarithm plotting.

The method can include performing regression to evaluate said resulting correlations and calculating regression using at least one method selected from the group consisting of least squares regression, linear regression, logarithmic function, and polynomial function.

### BRIEF DESCRIPTION OF THE DRAWINGS

FIG. 1. Is a graphic flow chart showing an embodiment according to aspects of the present invention.

FIG. 2 is graphical depiction of a two-dimensional slice of a simple theoretical STM tunneling junction involving two atoms.

FIG. 3 is a 2-Dimensional Depiction of Matrix Convolution according to aspects of the present invention.

FIG. 4A is a graphic depicting slices of s-wave tip volumes for an Au 6s tip according to aspects of the present invention.

FIG. 4B is a graphic depicting slices of s-wave tip volumes for a H 1s tip according to aspects of the present invention.

FIG. 5A is a graphic depicting the molecular structure of tryptanthrin according to aspects of the present invention.

FIG. 5B is a graphic depicting the molecular structure of 8-fluorotryptanthrin according to aspects of the present invention.

FIG. 5C is a graphic depicting the molecular structure of 4-aza-8-fluorotryptanthrin according to aspects of the present invention.

FIG. 6A is a graphical depiction of simulated STM topography of 8-fluorotryptanthrin according to aspects of the present invention.

FIG. 6B is a graphical depiction showing the drift-corrected experimental STM topography image of a single 8-fluorotryptanthrin molecule adsorbed onto HOPG according to aspects of the present invention.

FIG. 6C is a graphical depiction showing a simulated topographic image according to aspects of the present invention.

FIG. 6D is a graphical depiction showing an overlay of the simulated topographic image on the experimental STM image according to aspects of the present invention.

FIG. 7A is a graphical depiction of a DFT-calculated LUMO, topographic image, and dI/dz image of a single 4-aza-8-fluorotryptanthrin molecule according to aspects of the present invention.

FIG. 7B is a graphical depiction of a drift-corrected topographic image of a single adlayer molecule is shown with the molecular structure and outlines of the LUMO overlaid according to aspects of the present invention.

FIG. 7C is a graphical depiction of a drift-corrected dI/dz image of the same single adlayer (FIG. 7B) molecule is shown according to aspects of the present invention.

FIG. 8A an experimental dI/dz image of 4-aza-8-fluorotryptanthrin according to aspects pf the present invention is shown.

FIG. 8B a simulated dI/dz image according to aspects of the present invention is shown.

FIG. 9 is an illustration of Chen's Derivative Rule: a (a) A simulated topographic image of tryptanthrin using a Tersoff-Hamann zero-radius tip is shown at point “(a)”; the partial derivative of the sample with respect to x is shown at point “(b)”; the topography using a pₓ Gaussian function for the tip is shown at point “(c)”; (d) the partial derivative of the sample with respect to y is shown at point “(d)”; and the topography using a p_{y} Gaussian function for the tip is shown at point “(e)”.

FIG. 10A is a graphical depiction of the structure of tryptanthrin showing the historical convention for naming if the rings, and the numbering of each functionalizable atom.

FIG. 10B is a graphical depiction of the LUMO for tryptanthrin wherein the lobes of the LUMO are labeled according to the convention established according to aspects of the present invention.

FIG. 10C is a graphical depiction of the HOMO for tryptanthrin wherein the lobes of the HOMO are labeled according to the convention established according to aspects of the present invention.

FIG. 11A is a simulated topography and dI/dz image of tryptanthrin according to aspects of the present invention.

FIG. 11B is a dI/dz image of tryptanthrin wherein the individual lobes are labeled according to the convention established according to aspects of the present invention.

FIG. 12A is a simulated dI/dz map of tryptanthrin according to aspects of the present invention.

FIG. 12B is a simulated dI/dz map of 2-bromotryptanthrin according to aspects of the present invention.

FIG. 12C is a simulated dI/dz map of 2,4-dimethyl-8-fluorotryptanthrin according to aspects of the present invention.

FIG. 12D is a simulated dI/dz map of 2-methyl-8-fluorotryptanthrin according to aspects of the present invention.

FIG. 12E is a simulated dI/dz map of 3,8-difluorotryptanthrin according to aspects of the present invention.

FIG. 12F is a simulated dI/dz map of 1-methyl-8-fluorotryptanthrin according to aspects of the present invention.

FIG. 12G is a simulated dI/dz map of 4-aza-8-chlorotryptanthrin according to aspects of the present invention.

FIG. 12H is a simulated dI/dz map of 4-aza-9-chlorotryptanthrin according to aspects of the present invention.

FIG. 12I is a simulated dI/dz map of 1,4-diazatryptanthrin according to aspects of the present invention.

FIG. 12J is a simulated dI/dz map of 1,3-diaza-2,4-dihydroxy-8-iodotryptanthrin according to aspects of the present invention.

FIG. 12K is a simulated dI/dz map of 2,4-diaza-8-chlorotryptanthrin according to aspects of the present invention.

FIG. 12L is a simulated dI/dz map of 2-azatryptanthrin according to aspects of the present invention.

FIG. 13A is a graphical individual lobe QSAR plot of the IC50 value for the W-2 strain of malaria (P. falciparum) for the α1* lobe of tryptanthrin according to aspects of the present Invention.

FIG. 13B is a graphical individual lobe QSAR plot of the IC50 value for the W-2 strain of malaria (P. falciparum) for the α3* lobe of tryptanthrin according to aspects of the present Invention.

FIG. 13C is a graphical individual lobe QSAR plot of the IC50 value for the W-2 strain of malaria (P. falciparum) for the β1* lobe of tryptanthrin according to aspects of the present Invention.

FIG. 13D is a graphical individual lobe QSAR plot of the IC50 value for the W-2 strain of malaria (P. falciparum) for the γ1* lobe of tryptanthrin according to aspects of the present Invention.

FIG. 13E is a graphical individual lobe QSAR plot of the IC50 value for the W-2 strain of malaria (P. falciparum) for the γ2* lobe of tryptanthrin according to aspects of the present Invention.

FIG. 13F is a graphical individual lobe QSAR plot of the IC50 value for the W-2 strain of malaria (P. falciparum) for the γ3* lobe of tryptanthrin according to aspects of the present Invention.

FIG. 13G is a graphical individual lobe QSAR plot of the IC50 value for the W-2 strain of malaria (P. falciparum) for the δ1* lobe of tryptanthrin according to aspects of the present Invention.

FIG. 13H is a graphical individual lobe QSAR plot of the IC50 value for the W-2 strain of malaria (P. falciparum) for the δ2* lobe of tryptanthrin according to aspects of the present Invention.

FIG. 14A is a graphical plot showing threshold behavior for α3* lobe NLI values according to aspects of the present invention wherein the data are separated into 3 categories; at or above threshold (square), below threshold (diamond), and non-correlated (triangle).

FIG. 14B is a graphical plot showing threshold behavior for α3* lobe NLI values according to aspects of the present invention wherein the rectangle depicts the region of the plot which more clearly shows the threshold behavior.

### DETAILED DESCRIPTION OF THE PREFERRED EMBODIMENTS

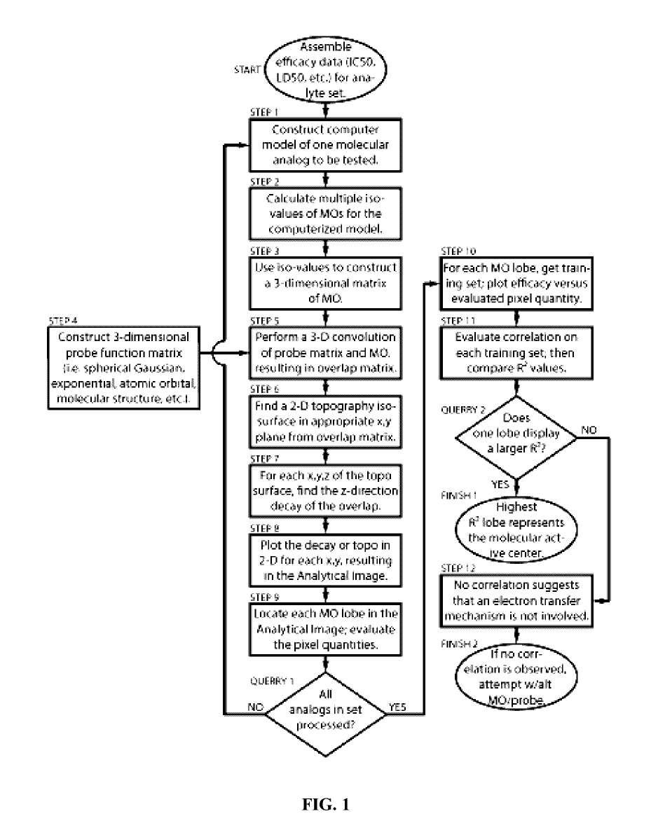

A detailed description of the embodiments for a novel process wherein a mathematical convolution function is utilized to model a target compound's interactions with other atoms or molecules will now be presented with reference to FIGS. 1-14B. One of skill in the art will recognize that these embodiments are not intended to be limitations on the scope, and that modifications are possible without departing from the spirit thereof. In certain instances, well-known methods, procedures, components, and circuits have not been described in detail.

Referring first to FIG. 1, a general schematic showing an embodiment of the present invention is disclosed.

Scanning tunneling microscopy (STM) is used as a topographic imaging tool for the electronic structure of material surfaces and/or surface-adsorbate systems. Theoretical predictions often accompany experiment in order to describe these images. Thus, artificially generated STM images are common in the literature, and a few simulators have been built to systematically predict topographic STM images.

In general, simulators lack the functionality to quickly and reproducibly characterize apparent barrier heights (φₐₚ), or onto functions thereof (dI/dz). In STM, the dI/dz image is representative of the potential barrier that an electron must pass through for tunneling to occur in a region associated with (and local to) the barrier (see Theoretical Basis section). Since φₐₚ is related to the local work function, the quantity dI/dz is of fundamental importance.

Knowledge of barrier heights and/or images associated thereto has application in determining the chemical specificity of surfaces, local electronic charge, and band-bending effects. Current differential scanning (tip z-axis modulation) functionality in modern simulators is thus essential in providing full capabilities to STM researchers. This is an important aspect since modern experiments employ tunneling barrier measurements in both more traditional studies, and in support of newer queries, such as the characterization of DNA interactions and behavior.

In typical STM operation, the x,y direction of a conductive tip is scanned over the surface of a sample while the z direction (height) is controlled by a feedback loop that is set to maintain a constant tunneling current. During the experiment, the current is measured and fed back to a control unit. If the current falls above or below the set point, a piezoelectric fine positioner will move the tip up or down to regain consistency. The height required to maintain the constant current is recorded at each x,y position over the scan, and then correlated by color and/or intensity to a representation of the x,y plane, to wit, the sample surface.

In doing this, the STM creates a topographic map of the overlapping quantum states that corresponds to a constant tunneling current. The simplest approximations assume the tip maintains a uniform and symmetrical structure over the whole scan, i.e., a sphere of constant value. With this approximation, the STM images correspond primarily to the local density of states of the unperturbed sample. In terms of molecular processes, this is taken simplistically to be the sample HOMO or LUMO, depending on whichever provides tunneling states between the Fermi levels of the tip and sample, after considering the polarity of the applied bias. It is important to note that under certain circumstances, the effects of the substrate states may be neglected. Specifically, when the substrate density of states near the Fermi level is at or near zero (as is the case for graphite) then under moderately low bias regimes the substrate states have decayed such that they have been observed to not contribute appreciably to tunneling. This is in stark contrast to the case for metal substrates where the density of states is typically at a local maximum at the Fermi level, and interfere with adlayer imaging. Thus recent progress has been achieved in imaging individual MOs under ultra-high vacuum conditions (where imaging on graphite is experimentally problematic) with the analyte molecules adsorbed onto a graphene-substrate system so as to provide distance from the states of the metal to where they have decayed to such a point that they are decoupled, and therefore may be neglected. Distortions due to the existence of the tip are common and more advanced computational approaches include tip structure in some way. In the method presented here, tip structure is included through a coupling function in a direct manner.

Theoretical investigations provide a means by which to correlate atomic and electronic structure by assigning the features in STM images to physical entities. This essential role in the interpretation of STM data develops the need for a systematic way of producing simulated STM spectra from theoretical models. Several theoretical descriptions of STM operation that attempt to provide a pragmatic relationship between actual and expected images exist. The computational application of these models is highly varied and often intimately related to a specific experiment. Thus one finds that, in many cases, the published simulated images have been generated as per experiment by a multitude of different techniques. We offer a new formalism which allows systematic, efficient simulation of φₐₚ or dI/dz STM images. Including these measurements within the simulator's fundamental functionality permits this property to be theoretically probed in an efficient manner.

The work presented herein reports on the successful development of a theoretical engine that simulates the mechanical operation of an STM. The simulator operates on, but is not limited to, local basis set representations of the wavefunction which may be provided by many computational chemistry programs. Departing from common theories, the tip and sample coupling is modeled by the mathematics of convolution and therefore tip effects upon the sample state are inherently included. Most importantly, a scheme by which to provide theoretical STM barrier heights and images is provided.

The results of the initial image generation simulations for topographic and dI/dz image modes are described herein. These indicate agreement with experiment and other theoretical models, implying that the approach disclosed is a fundamentally viable option. Furthermore, the time costs of the simulations are minimal, with the longest runtime to date being approximately two hours when operating on the highest resolution orbital volumes obtainable from preliminary DFT calculations on the non-interacting entities.

According to aspects of the present invention, molecular orbitals can be calculated using density functional theory (DFT) with numerous density functionals, via any Hartree-Fock (HF) method, or by any other method known in the art to calculate molecular orbitals.

The tunneling interaction of STM may be viewed analogously to the off diagonal interactions of the secular determinant expression in standard LCAO-MO theory. Within this approximation we represent the nth electronic orbital of the tip μ, and the mth electronic orbital of the sample ν, by a linear combination of i and j atomic orbitals, respectively.

Ψ_{μ}=Σₙ^{N}cᵢₙφᵢₙ (1)

Ψ_{ν}=Σₘ^{M}cⱼₘφⱼₘ (2)

This approach provides that, in many cases, the effective tunneling Hamiltonian may be approximated by considering the behavior of the overlap integral, an approximation that follows directly from reduced definitions of electronic structure, such as extended Hückel theory (EHT). EHT treatments lead to an off diagonal effective Hamiltonian that is characterized essentially by the overlap integral. Indeed it has been reported that experimental results can be replicated well by considering only the overlap of tip and sample states for alkanes adsorbed on graphite.

Based on these prior results we postulate that under LCAO descriptions of the tip, sample electronic structure: 1.) tunneling may be approximated by an electronic property that depends on the overlap integral, namely the electron density within the overlap, ρ(r); and, 2.) under highly descriptive electronic structure definitions such as available in LCAO calculations, this property is sufficient to characterize relative barrier height behavior. This assumes that these systems, when interacting with the STM tip, are under the influence of an effective Hamiltonian similar to the hopping integral which, as a first approximation, may be calculated by considering a reduced Hamiltonian that is essentially dependent on the overlap integral.

A standard definition of electron density within LCAO theory may be taken as:

ρ(r)=2Σₙ^{ocoMO}Σ_{i,j}^{basis}cᵢₙcⱼₙφᵢ(r)φⱼ(r) (3)

Inserting the tip and sample representations into this definition yields an approximation of the tunneling density.

ρ_{T}(r)=Σₖ^{TM}Σ_{i,j}^{basis}cᵢₖcⱼₖφᵢ(r)φⱼ(r) (4)

Where the inner sum is over all i,j atomic interactions within the basis sets of the tip, μ, and sample, ν, contributing to the kth “tunneling matrix”, TM. The outer sum is over k tunneling matrices, equal to the sum of all contributing molecular orbitals within M and N of the sample and tip, that contribute to tunneling. The factor of 2 from Equation 3 is dropped since the tunneling state, or matrix, is considered to be singly occupied as opposed to the double occupation of standard LCAO-MO theory. The total electron density available for tunneling is obtained by summing over all k TM's, where each TM represents a transition between a single occupied and a single unoccupied molecular orbital of the tip and sample. For example, TM=1 for considering only a tip HOMO to sample LUMO transition, or vice versa; TM=2 for considering a tip HOMO to sample LUMO transition and a tip HOMO to sample LUMO+1 transition; and so on.

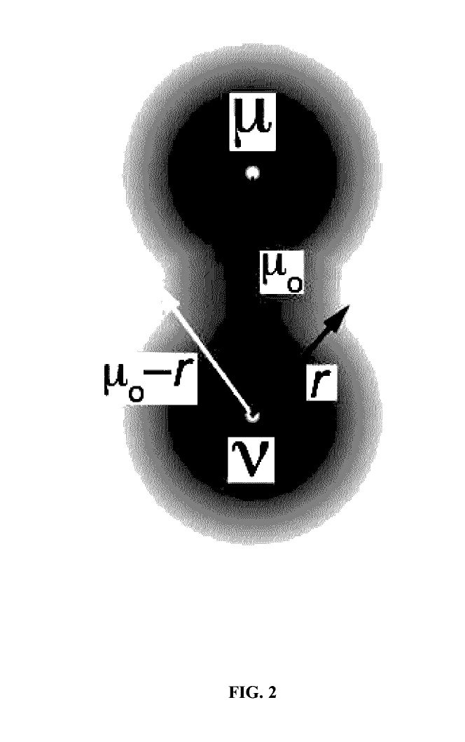

Referring now to FIG. 2, a graphical depiction of a two-dimensional slice of a simple theoretical STM tunneling junction involving two atoms (μ for the tip and ν for the ‘sample’) is shown. Each point of interaction within the volume can be described by the vector μₒ−r. Using a time-independent representation, we introduce our spatial dependencies via mechanical illustration of the STM.

Substituting these coordinate dependencies into the tunneling density expression, Equation 4, and integrating to obtain all interactions over, r→R, within the interacting space, dΩ, yields the following:

ρ_{T}(μ₀)_{i,j}=Σₖ^{TM}Σ_{i,j}^{basis}cᵢₖcⱼₖ×∫_{r<R}φᵢ(μ₀−r)φⱼ(r)dΩ (5)

Inserting the tip and sample representations, Equations 1 and 2, expanding the sum inside the integral, and finally summing over all k=TM returns the convolution integral.

$$\begin{matrix}{{ρ}_{τ} ( {μ}_{0} )}_{μν} = {{\sum }^{TM}}_{k} {{\sum }^{M}}_{n , m ( n ∉ m )} {c}_{in} {c}_{jm} \times {\int }_{r < R}^{ } {ϕ}_{in} ( {μ}_{0} - r ) {ϕ}_{jm} ( r ) d Ω \\ = {{\sum }^{TM}}_{k} {\int }_{r < R}^{ } {{\sum }^{M}}_{m} {c}_{jm} {ϕ}_{jm} ( r ) \times {{\sum }^{M}}_{n} {c}_{in} {ϕ}_{in} ( {μ}_{0} - r ) d Ω \\ = {{\sum }^{TM}}_{k} {\int }_{r < R}^{ } {Ψ}_{v} ( r ) {Ψ}_{μ} ( {μ}_{0} - r ) d Ω \\ = {\int }_{r < R}^{ } {Ψ}_{v} ( r ) {Ψ}_{μ} ( {μ}_{0} - r ) d Ω\end{matrix} \qquad ( 6 )$$

Where we consider the sample and tip basis set of the same size, i.e. M=N. This is not a restriction to our methodology, however, since in practice the sample and tip orbitals of interest are mapped to a 3-D grid, and the convolution integrals are carried out numerically using custom scripts within MATLAB™, a common interpretive software development tool. The non-interacting potentials are considered by populating the TM elements with LCAO-MO terms that have been derived from isolated-molecule quantum chemistry optimizations on the tip and sample; i.e., all TM elements that correspond to a non-interacting Hamiltonian are optimized in a preceding calculation, noting that a fully optimized tip model remains for future work.

The simulator explicitly considers transitions between the occupied and unoccupied states of the tip and sample, e.g., the HOMO to LUMO transition, the HOMO to LUMO+1, etc. To facilitate, the tunneling matrix includes elements associated only with occupied tip states and unoccupied sample states, or vice versa, depending on the defined bias polarity. Thus the tunneling matrix is always assumed to be occupied, and whether the occupation is initiated from the tip or sample side is implicitly included in the bias polarity of the simulation.

The simulator is capable of operating on other approximations of electronic structure such as the plane wave expansions common to solid state models. In these or other cases where a “density of states” is considered over discrete orbitals, a statistical approach to occupation such as a Fermi-Dirac distribution may be more appropriate.

The result of Equation 6 is pleasing since the convolution in general describes the coupling of two functions in terms of their overlap, consistent with the overlap approximation of the effective Hamiltonian described earlier for the EHT treatment of electronic structure. Since the overlap is a sufficient description for many cases, the tunneling current is expected to be proportional to the convolution result, Equation 6. More quantitative results may be achieved by using values from the isolated DFT calculations of the tip and sample to calculate terms for the EHT Hamiltonian. The overlap portion would, of course, still be described by the convolution result. Thus, many cases will exhibit tunneling currents that are proportional to the convolution of the tip and sample states that are available for tunneling, as expressed by

I∝(Ψ_{μ}*Ψ_{ν}) (7)

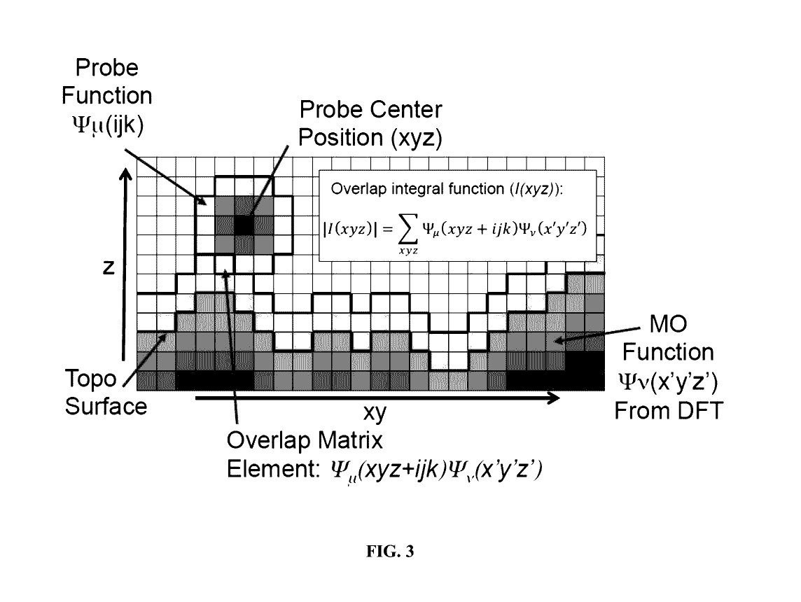

Turning now to FIG. 3, the MO function is toward the bottom, and the probe function is a ‘circle’; both are labeled in the figure. The overlap matrix is described by the center position of the probe (xyz). In the resulting overlap, the product is taken of the values from each contributing matrix, i.e. the MO function and the probe function, which is shown as Ψμ(xyz+ijk)Ψν(x′y′z′). Here the MO distribution location (x′y′z′) is equal to the center of the probe (xyz) plus the relative displacement within the probe function (ijk). Thus (x′y′z′)=(xyz+ijk). For a given (xyz), the resulting overlap integral function, given as |I(xyz)|, is computed as the sum of each product over the entire volume for the probe position (xyz); the equation is shown in the figure. A topographical surface may then be determined from the overlap. Also, the decay function for each (xy) position may then be determined along the chosen (z) direction.

From the correlations made between the tunneling matrix, the convolution, and the tunneling current, apparent barrier height measurements may also be approximated by the convolution. Substituting the convolution for the current-dependent terms of the apparent barrier height, φₐₚ, yields the following equation, which includes the proportionate convolution approximation (Equation 7) on the RHS.

$${φ}_{ap} = \frac{ℏ}{8 m} {( \frac{d InI}{d z} )}^{2} = \frac{ℏ}{8 m} {( \frac{1}{1} \frac{d I}{d z} )}^{2} ∝ \frac{ℏ}{8 m} \times {( \frac{1}{( {Ψ}_{μ} ⋆ {Ψ}_{ν} )} \frac{d ( {Ψ}_{μ} ⋆ {Ψ}_{ν} )}{d z} )}^{2} \qquad ( 8 )$$

To compare with experiment, simulated dI/dz images are reported here. An approximation of the tunneling current in accordance with Equation 8 is easily obtainable by squaring the dI/dz image values. Experimentally, the dI/dz image is a map of the lock-in amplifier output (which is proportional to dI/dz). While not a true barrier height (which can be obtained from Equation 8), it does show an onto functional correspondence to the barrier height (for positive d ln I/dz values) in that brighter portions of the dI/dz image represent higher barrier heights on the surface.

According to aspects of the present invention, the method for determining the potential energy barrier to an electron state described herein can include any other method for determining the potential energy barrier to an electron state known in the art, whether determined indirectly via the decay, i.e., dI/dz, or via some other direct calculation or measurement of the barrier.

First principles treatments are known to underestimate tip to sample separation distances (20) so that possibility is noted in these simulations. For cases where a more accurate quantification of tip-sample separation distance is required, a convolution treatment related to Bardeen's tunneling theorem has been provided in terms of a k-space integration under conditions of the vacuum Schrödinger equation in the coupling region. Either by assumption of orthogonality, or through an orthogonalization scheme for the basis set, it should be possible to adopt those results here, since in general, a weighted linear sum of orthogonal basis functions is a discrete summation approximation of the continuous k-space integral. This would be straightforward when considering only a single atomic orbital for each atom, since each atomic center could then be correlated to a single k-point consisting of only one basis function. In practice a single atom is associated with a collection of basis functions which may not share a common center with the atom. Thus each k-point is not necessarily associable with an atomic center and its value is dependent on a linear set of several eigenvectors. Therefore, while varying in difficulty, a full treatment of the hopping integral in terms of convolution mathematics is within reason, and available for cases in which an accurate description cannot be attained without invoking a treatment for the Bardeen-like term. For a full analytical treatment of Bardeen's theorem, in terms of the LCAO approximation, see Blanco, et al.

It should be noted then that the LCAO approximation used here and Bardeen's original expression are coupling models of the isolated systems, and while overlap treatments allow for distortion of the wavefunctions by inclusion of a tip structure, they do not directly allow for structural relaxation due to the tip. Within these regions, the convolution treatment here is no longer a good approximation unless the new atomic positions are known. To allow for these geometric rearrangements requires calculations on the tunneling system as a single collection of particles within the same solution space. In terms of the LCAO approximation, this leads to a full ab initio calculation at each tip position, followed by a geometric change based on the resultant forces; a time consuming process for even small systems. The approach presented here calculates the force integrals the same as would be done in that case, but does not allow them to induce atomic repositioning for structural optimization; it can therefore be considered a rigid approximation of the full ab initio approach.

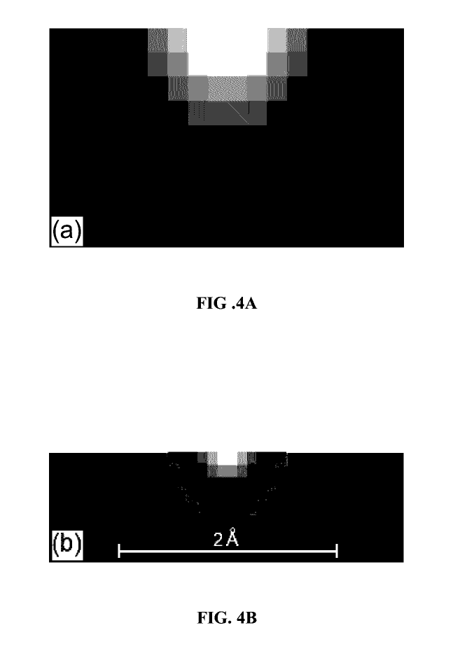

For simulations that include effects due to the tip structure, selection of a tip model becomes important. The initial tip should have qualitatively predictable distortions on the sample, be as simple as possible, and be extendable to full LCAO descriptions of the tip structure. A spherical tip model is chosen such that distortions should not significantly alter the sample structure in accordance with the Tersoff-Hamman prediction. A linear combination of s-type, contracted Gaussian functions fits the spherical requirements and is a form that is extendable to much larger basis sets. Thus the STO-3G 1s orbital of hydrogen makes an attractive choice for the first tip model. On the other hand, a metallic tip is a more realistic model, and a portion of the experimental STM reference data was collected with a gold tip. Therefore, a 6s gold orbital from the Hay-Wadt basis set was also investigated. A volumetric slice of each tip is shown in FIG. 4A and FIG. 4B, where the tip radius is defined as the vector originating from the center of the tip and terminating roughly inside the region of space where the amplitude of the tip function falls below ˜0.0005, indicated by the red lines shown in FIG. 4A and FIG. 4B. Each pixel is clearly resolved as an individual rectangle in the image. A scale bar is provided that is accurate for both tips. The two images are to-scale with one-another; however, the pixel sizes are different—the pixel size of the Au tip shown in (a) is ˜0.18 Å/pixel, and the pixel size for the H tip in (b) is ˜0.09 Å/pixel. Thus the pixels for the H tip are half the size of those for the Au tip. The red lines indicate the defined tip radii where the tip amplitudes fall below 0.0005. The native distance scale of 0.18 Å/pixel results in a radius of about 1.44 Å for the Au 6s tip FIG. 4A and reducing the pixel size by half results in a radius of about 0.54 Å for the H 1s tip FIG. 4B, both acceptable values for their corresponding atoms. All tip models are normalized to 1 over their own volume to standardize amplitude enhancement due to the tip-sample interaction.

At similar amplitudes, details in the simulated topographic images became less distinct using the Au tip, as one would expect, and it was found that the simulated image features were fused together beyond what is observed via experiment. This is consistent with what has been reported for other STM theoretical models. The reasoning given in these cases is that metallic s orbitals are too large to provide the lateral resolution typically observed experimentally. As reported in other studies, it is offered that tunneling must occur from the axially aligned portion of the d_{z}² orbital for which a reduced radius spherical tip model sufficiently describes most cases. Since an arbitrary retraction of the Hay-Wadt Au 6s orbital results in a tip without definite theoretical or realistic foundation, the STO-3G tip model is applied for the initial simulations reported here. A d_{z}² tip model built using contraction coefficients and alpha constants for the 5d Au orbitals of the Hay-Wadt basis set, with the azimuthal component removed, has seen preliminary usage; early results indicate more lateral resolution than the Au 6s tip, but less than the STO-3G tip. Relative to experimental results, image features for the d_{z}² tip model have not, thus far, provided significant improvement over the STO-3G simulations. For deriving the MO structures, all DFT calculations were performed using Spartan'14, with the B3LYP functional and the 6-31G* basis set. Molecular models included all atoms, including hydrogen atoms.

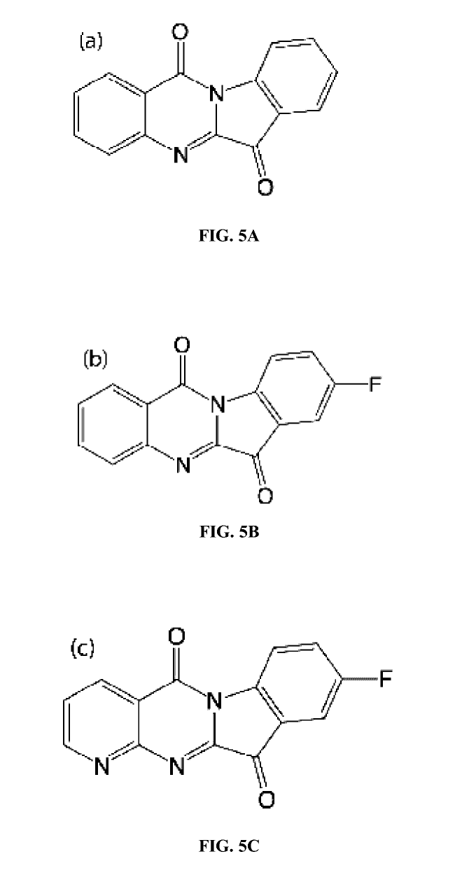

Specific molecules of interest within our research group have been a class of planar aromatics based on indolo[2,1-b]quinazoline-6,12-dione, commonly known as tryptanthrin. FIGS. 5A-5C show the structure of tryptanthrin, as well as two additional analogs that are discussed herein (8-fluorotryptanthrin and 4-aza-8-fluorotryptanthrin).

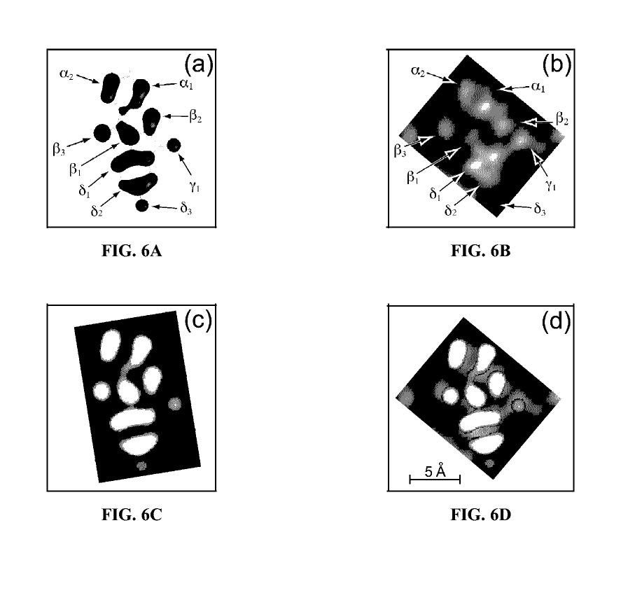

Experimental STM images of tryptanthrins show resolved features that correspond well to the individual lobes of gas phase DFT predicted molecular orbitals. Data from these and other STM tryptanthrin investigations serve as an experimental reference set for this computational study. Thus, the simulator was applied directly to in-house topographic images of 8-fluorotryptanthrin. FIG. 6A shows the DFT-calculated HOMO (isovalue=0.032) which can be compared to the experimental topography (collected under negative sample-bias conditions; −0.80 V, 100 pA) shown in FIG. 6B. Individual lobes of the HOMO are labeled in FIGS. 6A and 6B according to the convention established according to aspects of the present invention. A simulated topographic image is shown in FIG. 6C, which shows lobe-to-lobe agreement with the experimental results in FIG. 6B. By inspection, the predicted and experimental images coincide very closely in the spatial arrangement of nearly all lobes. The topography height information also shows good agreement, especially for the β₃ and δ₃ lobes whereby they have a diminished brightness relative to the other lobes in both the experimental and simulated images. The γ₁ lobe is diminished in size for the simulated image yet retains a small spot of relatively high brightness over the center of the lobe. This is in partial agreement, and the experimental diminishment can be explained to arise from a slight geometrical bending due to adsorption as has been described previously for this class of compounds, and this analog in particular. This geometry change raises the γ₁ lobe in the real system, making it a physically higher feature. The result is brighter-than-expected features for this region, which in turn produces slightly dimmer relative values for the β₁ lobe than predicted by the simulator. FIG. 6D shows an overlay of the simulated and experimental images. This image again exemplifies the excellent agreement in lobe size, brightness, and position. Also, while not fully resolved, there is a dim spot corresponding to the node between the δ₁ and δ₂ lobes. Compared to earlier reports on experimental results for this same molecule, the simulator offers improved agreement relative to techniques based solely on DFT-predicted orbital surfaces, especially in the δ₃ region.

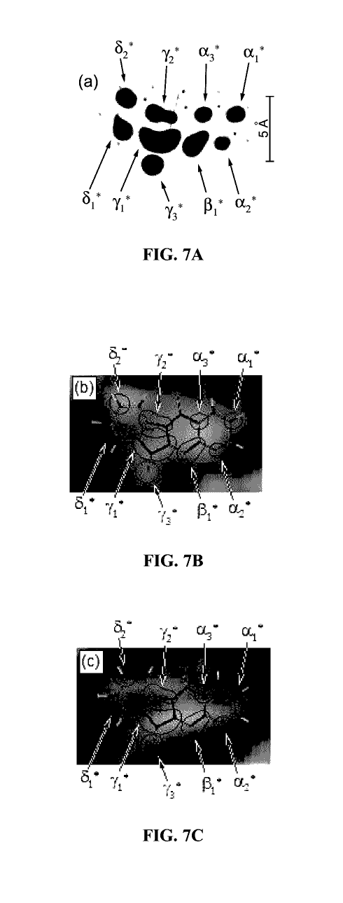

While the 8-fluorotryptanthrin offered some of the best topographic experimental results, its analog, 4-aza-8-flurotryptanthrin, provided the best to-date experimental dI/dz images in terms of sub-molecular resolution. FIG. 7 shows the LUMO of 4-aza-8-fluorotryptanthrin, as well as the experimental topographical STM image and corresponding experimental dI/dz image for a single molecule (+0.80 V, 100 pA, 6 kHz modulation, and dz=0.19 Å). Individual lobes are labeled according to the convention established according to aspects of the present invention. These data will be cited for experimental comparison of the computational results.

For this computational approach, the dI/dz images are calculated as proportional to the first derivative of the convolution along the z-axis, according to the approximation in Equation 8; the preceding term,

$$\frac{{R}^{z}}{8 m} ,$$

and the inverse VSP,

$$\frac{1}{( {Ψ}_{{μ}_{n}} , {Ψ}_{{v}_{n}} )} ,$$

are constants that are omitted in this first approximation. The measurement is made by modulating the tip in the z-direction and recording differences in the tunneling amplitude (as approximated by the convolution) similar to realistic STM operational modes which record tunneling currents over the tip z-modulation. In this mode, the simulator constructs dI/dz images from the same volumetric representation of electronic structure as the topographic images. If these data generate a topographic image in accord with experiment, it suggests that an accurate electronic structure is approximated well by the volumetric data. This in turn implies that a dI/dz map constructed from the same data would be built upon an accurate approximation of the probed electronic structure, ultimately building confidence in the accuracy of the dI/dz map. Performance of the dI/dz simulation was evaluated using case-specific real-world measurements of 4-aza-8-fluorotryptanthrin obtained by our group. The experimental parameters are thus known completely, and the simulated dI/dz measurements operate on data that are in good agreement with experiment.

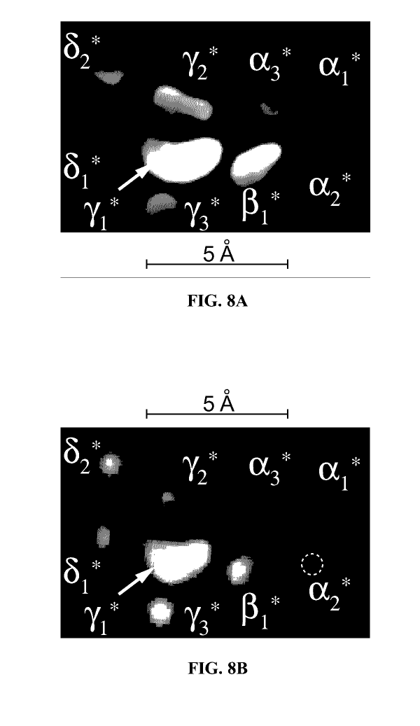

The experimental and simulated dI/dz images are presented in FIG. 8A and FIG. 8B, respectively. The experimental image shown in FIG. 8A was taken from the same data as those shown in FIG. 7C; however, DFT predictions were used to construct a mask of the orbital lobes that was manually applied to the experimental dI/dz image. The individual lobes are labeled for convenient identification, again according to the established convention. This visualization helps to emphasize the portions of the dI/dz image that result predominantly from the molecular orbitals, as opposed to substrate states. Thus the resulting image in FIG. 8A shows the dI/dz data only for regions where the MO amplitude is large. The excellent agreement between these images is immediately apparent. The γ₁* lobe is the brightest of the lobes in both images. The next highest intensity is the β₁* lobe. Other lobes show general agreement as well. For instance, the α₁*, α₂*, and α₃* lobes are dim in both images. Indeed, the α₂* lobe is essentially non-visible in FIG. 8B (indicated with a dashed circle; though non-zero values are present in the data, they are generally too dim to see in a gray-scale image), and it is the smallest and dimmest feature in the experimental result as well, FIG. 8A. Fine details within each lobe are apparent, and agree quite well between experiment and theory. For instance, within the β₁* lobe, the left side is brighter in both FIGS. 8A and 8B. For lobe γ₂*, the left side is brighter in both. And lobe γ₃* (over the indolo carbonyl) is brighter near the upper edge of the lobe in both images. Apart from these correlations, there are minor subtle differences that are possibly due to the influence of the substrate states on the experimental measurements. Despite the minor differences, it is clear that the simulated dI/dz images provide a remarkably high degree of accuracy in their prediction of the experimental results.

One interesting aspect to these results is that, for these adlayer systems under the correct tunneling conditions, the individual MOs are apparent in the STM images. Based on the experimental results, it appears that the individual HOMO and LUMO states contribute predominantly to the tunneling. Specifically, it appears that states other than the frontier orbitals do not appreciably contribute (i.e. HOMO−1 or LUMO+1, etc.). This is unlike some other STM studies of aromatic adlayers. It is hypothesized that this is because tryptanthrins are smaller molecules, and thus their MO energies are spaced farther apart. This is borne out by gas-phase DFT calculations where, for the parent compound, the HOMO−1 state is 0.52 eV beneath the HOMO energy, and the LUMO+1 is 1.26 eV above the LUMO energy. Granted, these states would relax toward each other upon adsorption; however such relaxation is not sufficient for the MOs to appreciably overlap energetically. Thus by carefully selecting a relatively low bias voltage (+/−0.80 V), the images correspond to the individual MOs, as is clear from the excellent correlation of theoretical and experimental data presented here and elsewhere for these systems. Because of this, the simulations need only consider the individual frontier MOs. However, it may become necessary to consider mixed MO states for other systems (especially larger molecules where the MOs are energetically closer together). Such an approach would necessarily require the treatment of overlapping MO lobes of differing phase, and an assessment of the resulting constructive and destructive interferences.

Verification of the convolution approximation against established ab initio approaches is a concern. A longstanding issue with STM simulations has been the inclusion of tip-induced distortions. Since there have been ab initio treatments to describe these phenomena, and the convolution explicitly includes tip structure, this issue constitutes a robust comparison point between theories. A well-established result for the inclusion of tip effects is Chen's derivative rule. This rule does not include the tip structure directly, but approximates its effect as the nth derivative of the sample wavefunction where n corresponds to the m_{g} quantum number of the orbital components used to express the tip model. For example, σ-type orbitals (s, p_{z}, d_{z}_{²}) correspond to Ψ_{μ}, or the zeroth partial derivative, π-type (pₓ, d_{xz}), orbitals correspond to the first partial derivative of Ψ_{μ}, and δ-type (d_{xy},dₓ_{²}_{-y}_{²}) orbitals correspond to the second partial derivative of Ψ_{μ}. Chen's results are derived from a treatment of the Helmholtz equation, whereby the tip and sample are expanded in spherical Bessel functions using parabolic coordinates.

For this comparison the simplest tip model that would provide comparable results between theories was considered. Since the spherical tip case is approximated as the zeroth derivative in Chen's derivative rule, a spherical tip should offer no significant distortion to the sample image. While this would make a correct test case fundamentally, agreement is achievable by simply doing nothing to the sample structure. This unremarkable result is therefore a conceptually unconvincing test case. For this reason a single primitive Gaussian which corresponds to a p-type orbital shape was chosen as the comparative tip model. There is no contraction and the exponential coefficient does not correspond to any true p orbital, so this model does not represent a real tip structure in any way. It was chosen to provide an obvious amount of distortion that should be comparable to those predicted by Chen's derivative rule.

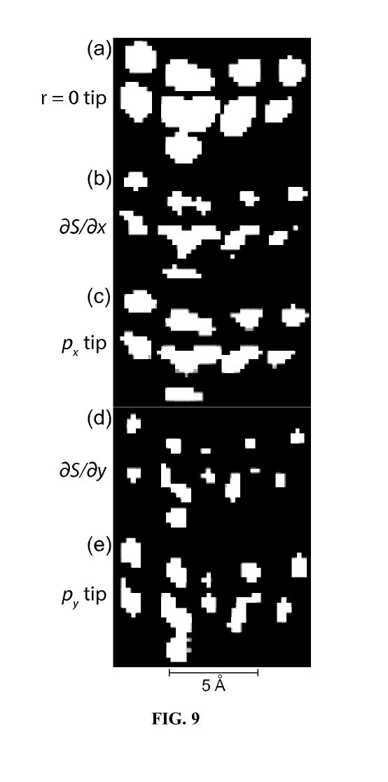

Both a p-type Gaussian lying along the x-axis and one along the y-axis were chosen for the tip in order to make multiple comparisons. From Chen's derivative rule, the results of convolutions involving these tips should be predictable by the partial derivative of the sample with respect to x for the pₓ Gaussian, and with respect to y for the p_{y} Gaussian. For the sample, 4-aza-8-fluorotryptanthrin was chosen; this molecule provides more complex electronic structure than benzene, and therefore more characteristic detail by which effects may be measured. For reference, a DFT-predicted topographic representation of 4-aza-8-fluorotryptanthrin via a Tersoff-Hamann zero-radius tip (thus the sample structure is unperturbed by the tip) is shown in FIG. 9 at point “(a).” The results of the partial derivative (taken directly of the sample structure) and the corresponding convolution involving a pₓ Gaussian are given in FIG. 9 and points “(b)” and “(c),” respectively. One can see that Chen's derivative rule approximates the convolution method very well. Both methods qualitatively result in the same features, indicating similar distortions to the raw sample image. The relative brightness of the features suggests quantitative agreement as well. The convolution, FIG. 9 at point “(c),” shows a spatial broadening that is not present in the direct partial derivative. This is due to the actual inclusion of a tip structure in the convolution as opposed to a finite point-source as considered in the derivative rule. When the same type of analysis is applied to the p_{y} Gaussian, similar results are achieved (FIG. 9 at points “(d)” and “(e)”) that show strong agreement between Chen's approach and the convolution approximation applied here.

Both topographic and dI/dz STM simulations have been presented, as well as detailed tip interaction dynamics. Good to excellent results indicate the strength of the convolution approximation in STM simulation. This effective STM simulator allows direct inclusion of tip structure and is a first in producing interpretable, consistent images associated with MO-mediated tunneling barrier heights for molecular adlayers. Currently, using only a single processor, the simulator takes less than two hours to complete a high-resolution simulation of one tryptanthrin molecule. After the simulation, VSP changes and tip modulation experiments may be performed in seconds, indicating the value of the simulator in storing theoretical libraries of electronic structure.

Future applications will guide the development of expanded simulator functionality. For instance, under higher bias conditions, one would expect simultaneous tunneling to or from more than one orbital. Eventually, the simulator will be used to evaluate interactions with multiple states, providing a means by which to experimentally tune basis sets employed in describing tunneling, and/or other long-range interactions. Other modifications will be made in subsequent implementations to enhance the simulator performance significantly, such that large cluster models (200-500 atomic centers) of adsorbate-surface systems may be investigated efficiently. The long-term goal of this research is the extension of this simulator to various aspects of STM operation, utilizing the output from any standard quantum chemistry program.

### Example 1

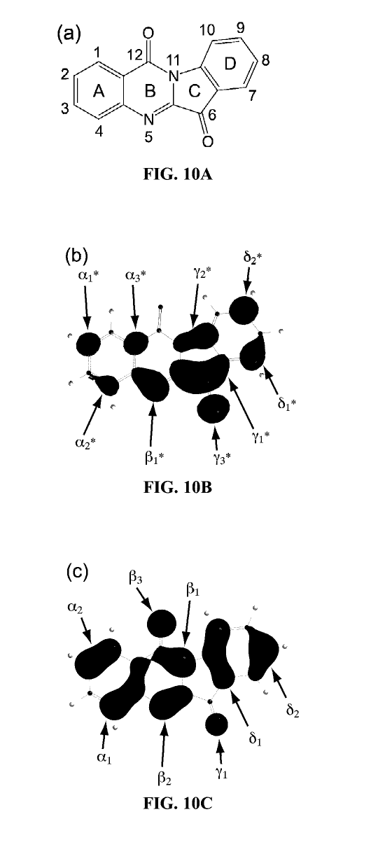

The class of compounds described and used herein are based on indolo[2,1-b]quinazolin-6,12-dione as shown in FIG. 10A. Otherwise known as tryptanthrins, this class of alkaloids has generated interest as potential therapeutic agents due to their easy synthesis, stability, unique ring structure compared to other drugs, and activity against a broad spectrum of pathogenic organisms that cause a variety of disease.

Disclosed herein is an expansion and refinement of the existing QSAR data based on molecular orbital (MO) theory that is the first application of a MO-based methodology to carry out QSAR. Not biased by the identity of atomic centers or specific functional groups denoted by resonance theory, this disclosure is based on the electronics and barrier height energies associated with tryptanthrins' frontier molecular orbitals (shown in FIGS. 10B and 10C) and points to a region of the tryptanthrin molecule that could possibly be a pharmacophore against P. falciparum.

The quantum descriptor utilized in this study is grounded in experimental data generated through use of STM to visualize the topography of MOs, and gather information about the energetic barriers of electron tunneling. This tunneling barrier represents the energy that an electron must overcome if it is to transition into or out of an electronic state. Additionally, this barrier affects the disposition of the associated MO; generally speaking, a lower barrier will correspond to a larger, more diffuse electron state. Therefore, it is reasonable that an electron state's barrier height energy could affect the rate of electron transition into or out of a MO via either a reduced energy pathway and/or a more expansive electron state.

With regard to tryptantrins' frontier molecular orbitals (HOMO and LUMO) whose roles would be critical to recognition, binding, and subsequent reaction with a biochemical receptor, it can be expected that the lower energy, occupied MOs would perturb the electronics of the HOMO and LUMO. In other words, although a frontier molecular orbital may be topographically delocalized over the entire molecule, the barrier heights associated with electron transfer into or out of the MO can differ with respect to the different lobes that comprise the MO.

More specifically, we have reported experimental observation of the spatial variations of molecular orbital barrier energetics, as well as an associated theoretical and computational interpretation of these experimental observations. Regions of low barrier height in a LUMO could be associated with increased rates of reduction and covalent modification via nucleophilic attack, whereas low regions of barrier height in the HOMO could be associated with increased rates of oxidation. A significant experimental and theoretical advantage of this approach is that it relies entirely on spatial measurements and/or calculations. Thus it provides information regarding energy barriers while not limited by the uncertainty principal, and provides feasibility to carry out submolecular-scaled measurements.

The computational approach disclosed comprises a 3-dimensional convolution of the molecular orbital states of a molecule of interest with a simulated ‘tip’ atom. Iso-values can be used to construct a 3-dimensional matrix of the molecular orbital. Alternatively, a 3-dimensional matrix of iso-values can be obtained directly. Note that the 3-dimensional matrix may be described in Cartesian coordinates, polar coordinates, or any other viable coordinate system. The method may also include a mixture of multiple MOs.

To construct a 3-dimensional probe function matrix, the probe function may be comprised of a pure mathematical function such as a spherical Gaussian function, a spherical exponential function, an atomic orbital function (e.g. a p-orbital, or a d-orbital), a molecular structure, a probe molecular orbital, or some other pertinent function known in the art, or combinations thereof.

A volume matrix was constructed from the convolution which could be utilized to generate a simulated topographical surface, as well as a simulated dI/dz image which is closely related to the apparent barrier height φₐₚ, where φₐₚ is proportional to (dI/dz). Perform a convolution of the probe matrix and the MO matrix. The resulting matrix is the ‘overlap matrix.’ Note that there are multiple methods for finding the overlap matrix, which can be accomplished in one or more dimensions, as well as by determining the convolution form Fourier/convolution theorem analyses such as determining the reciprocal-space probe and MO functions, taking the reciprocal-space product and then performing an inverse Fourier transform to arrive at the real-space convolution function, or any other method of finding the interaction between the probe function and the molecular orbital.

In addition, the method may be implemented without the use of a matrix by some other direct mathematical description of the molecular orbital and the probe in any dimension (i.e. via polynomial functions and the like), with the overlap function determined directly.

The dI/dz images are valid for regions of high MO amplitude, and are thus valid for the frontier MO states that are heavily involved in chemical reactivity. Since the variation in barriers might significantly influence such chemical reactivities, especially with regard to spatial optimizations, this computational approach was used to develop a novel tunneling barrier-based QSAR descriptor. Such a descriptor would have a significant advantage in that, being very regio-selective, multiple QSAR training sets could be constructed, each for a different sub-molecular portion of the molecule. For this work, individual lobes of the pertinent MO were convenient sub-molecular partitions with which to consider. Since each MO lobe could then be utilized to construct a potential QSAR training set, a single set of molecules with a single biological activity, could generate several training sets. Presumably, some of the training sets would show little correlation since they may not actually be involved in the critical aspects of the biological activity. However, one (or a few) lobes would potentially show a strong correlation, indicating the critical portion of the MO for the desired biological activity. Thus, this method would be able to identify the pharmacophore of even small molecules based entirely on the properties of the class of molecules themselves.

The approach described herein uses a convolution between two 3-D matrices. One matrix describes the tip wavefunction, and the other describes the molecular wavefunction (i.e. the pertinent MO). The value of each element of the resulting convolution matrix is proportional to a tunneling current between the tip and the MO state investigated. Thus a simulated topography can be found as a surface of constant values within the convolution matrix.

Find a 2-dimensional topography iso-surface in an appropriate x,y plane, or other surface, from the overlap matrix. Note that x,y plane or other surface may be selected using any pertinent directionality or coordinate system relative to the analyte molecule; for example, in a Cartesian coordinate system, the x, y, and z directions may be selected according to any desired property of the analyte molecule. For example, parallel to or perpendicular to a particular bond axis.

Subsequently, virtual dI/dz values can be obtained by simply finding the difference between z values of the convolution matrix at each x,y point across the corresponding topographical surface. The tip wavefunction used for the current study was obtained from a Gaussian decay with a spherical symmetry.

For each x,y of the topography surface, find the z-direction decay of the overlap. Numerous methods exist for determining the decay, such as a fit to a pertinent mathematical decay function, for example, exponential, Gaussian, Lorentzian, polynomial, linear, or any other appropriate function. According to aspects of the present invention, dI/dz is utilized as a measure of the decay where I(x,y,z) is the value of the overlap matrix, i.e., the result of the convolution integral, and z is the selected analysis direction. Also note that the physical interaction may result from any sort of charge interaction wherein the molecular orbitals are important, including reduction, oxidation, hydrogen bonding, coordination, and the like.

The inventors' studies indicate that such a tip function provides good agreement with experimental STM images of tryptanthrins. Also, the virtual set point value was, and the virtual tip modulation was 0.4 Å. The resulting dI/dz data were then output as contrast and brightness balanced tiff images for more convenient subsequent processing. Plot the decay, for example, dI/dz, or topography function in 2-dimensions for each x,y location or such analogous location, depending on the coordinate system utilized, resulting in the Analytical Image.

This approach was applied to several tryptanthrin analogs for which the IC₅₀ values were available in the reported literature. The MOs of each analog was calculated using B3LYP density functional theory (DFT) with a 6-31G* basis set, via Spartan'14 software. The Spartan'14 output was parsed into a 3-D matrix format using a script written by the inventors. Due to constraints of the parsing script, selection of tryptanthrin analogs was limited to those analogs for which the center of mass for each molecule was contained within the molecular plane.

The resulting dI/dz tiff images were then analyzed using Adobe Photoshop™ graphics processing software, which proved to be a very convenient means of data analysis since the individual lobes of each MO could be clearly identified. Pixels contained within each individual MO lobe were carefully selected such that a histogram of the individual lobe was produced. From the histogram, the sum of all pixels within each lobe could be determined; this is termed the lobe integral, which was subsequently normalized within each lobe type for ease of comparison. Locate each MO lobe, or other pertinent MO feature, in the Analytical Image and evaluate the pixel quantities. The evaluation may include summing, finding the average, median, maximum, minimum or other descriptor over the lobe, the evaluation of individual pixels, or multiple or single pixels within some other appropriate region).

QSAR plots were then constructed for a given MO, one for each identifiable lobe in the molecule, by plotting the IC₅₀ values versus the normalized lobe integrals (IC₅₀ values for both the W-2 and D-6 strains of P. falciparum were taken from the available literature). For each MO lobe, get training set and plot efficacy versus evaluated pixel quantity. Note that this may be plotted in numerous ways, including but not limited to linear plots, logarithm plots, etc.).

This resulted in numerous QSAR plots, each one corresponding to the location of an individual lobe within the molecule. Thus, a high degree of regiospecificity was achieved for each QSAR plot. Least squares regression was then performed for each QSAR plot, and were used to determine if a correlation existed between each lobe and the anti-malarial efficacy. After evaluating the correlation on each training set, R² values are compared. Note that the evaluation may be a linear regression, or a regression of other mathematical forms such as a logarithmic function, polynomial function, or the like.

This approach was repeated for the DFT calculated LUMOs and HOMOs of the tryptanthrin analogs, as well as for the reported IC₅₀ values of both W-2 and D-6 strains of P. falciparum.

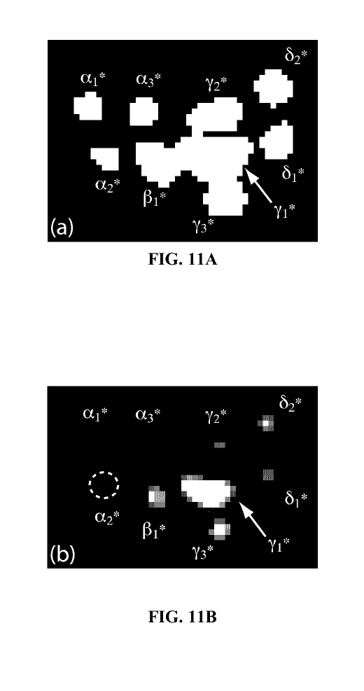

Referring now to FIGS. 9A and 9B, a simulated topography image (FIG. 9A), provided for reference) and a corresponding simulated dI/dz image for the LUMO of the tryptanthrin parent compound (FIG. 9B) are shown. The lobes have been labeled as in FIG. 10B. The brightness of each pixel (0-255) of the image in FIG. 11B corresponds linearly with the simulated dI/dz value (which is functionally onto with φₐₚ, thus the lower dI/dz values correspond to lower φₐₚ values, and vice-versa). As mentioned above, it is important to note that these simulated images have been observed to match very closely to experimentally obtained dI/dz images.

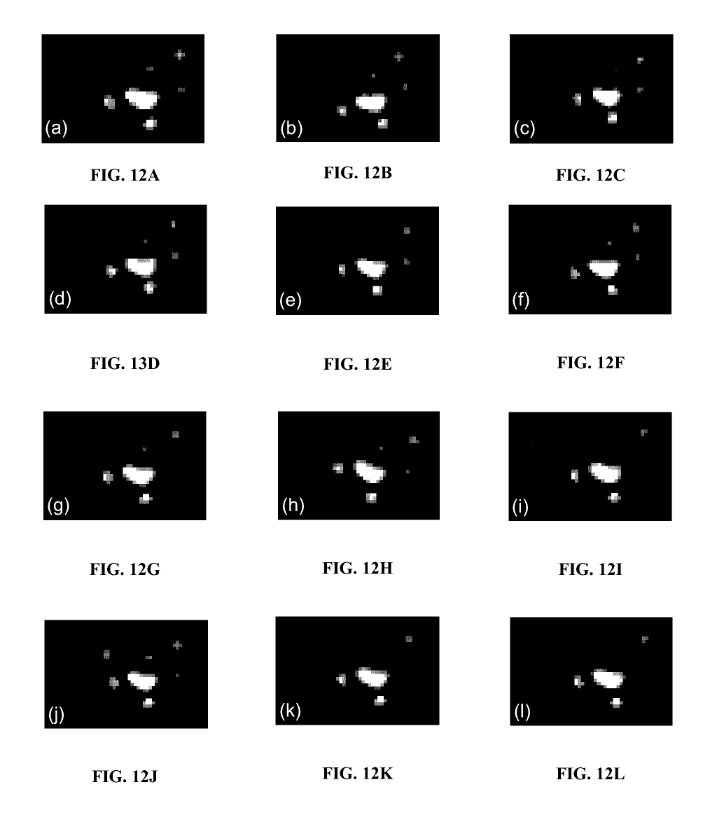

FIGS. 12A through 12L show simulated dI/dz images for the twelve analogs for which simulations were performed (that is, those that had a center of mass within the plane of the molecule, as well as IC₅₀ values versus P. falciparum reported in the literature). As can be seen in the images, while the overall shape of the dI/dz maps are very similar, there are subtle differences between analogs. The red arrow indicates the dI/dz values associated with the α3* lobe. As can be observed from FIGS. 12A through 12L, each analog displayed roughly similar patterns of intensities. For instance, for each analog the γ₁* lobe is the largest and brightest of all that are observed. Furthermore, the α₁*, α₂*, and α₃* lobes are the dimmest of all of the lobes.

An analysis of FIG. 11B and FIGS. 12A-12L, indicates that it is clear that the lobe with the lowest associated barrier height is the α₂* lobe. Indeed, the presence of the α₂* lobe isn't immediately obvious in the image in FIG. 11B, since its dI/dz values are so low. Thus, if all lobes were equally accessible, these data suggest that a reduction event would most likely occur at the α₂* position. However, as noted above, biological receptors may introduce their own geometrical constraints. Thus, while the α₂* lobe may have the lowest φₐₚ, that lobe might not be involved in the biological activity. In this case, some other lobe would correlate to the biological activity.

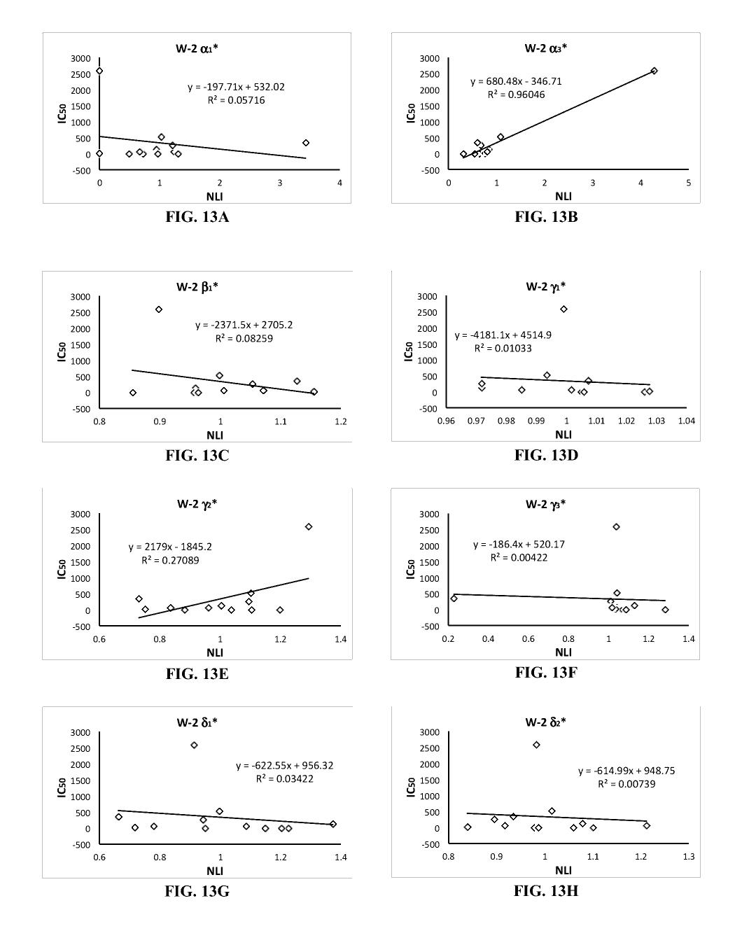

In order to correlate the measured barriers to efficacy, as mentioned above, a simple analysis of each of the lobes in each of the dI/dz images resulting in an integral of the pixels across each lobe was performed. These values were then normalized, resulting in the normalized lobe integral (NLI), against which the IC₅₀ values of the W-2 strain of P. falciparum were plotted for each recurring lobe. The tryptanthrin architecture results in nine recurring lobes in the LUMO (i.e. those labeled in FIGS. 11A and 11B). However, the α₂* lobe was not easily discernible in the dI/dz images, therefore no plot was generated for this lobe (FIG. 11B). This resulted in eight QSAR training set plots, one for each discernible LUMO lobe. These eight plots are shown in FIGS. 13A-13H. Each plot corresponds to a training set associated with an individual lobe of the LUMO of tryptanthrin. The plots are of IC50 values versus the normalized lobe integral (NLI). As can be seen in the plots, only the α3* lobe shows good correlation (R2=0.96046), thus providing the hypothesis that the α3* lobe is critical to the activity versus P. falciparum. Linear least-squares regressions were performed on each data set; the best-fit lines, as well as their equations and correlation coefficients (R² values) are displayed. Since the goal is to determine where in the molecule a correlation exists, the correlation coefficients for each lobe are summarized in Table 1. Table 1 also includes results for the D-6 strain of P. falciparum.

TABLE 1
Lobe-by-lobe correlations for tryptanthrins vs.
W-2 and D-6 strains of P. falciparum.

| Lobe | R² vs W-2 | R² vs D-6 |
|---|---|---|
| α₁* | 0.05716 | 0.05919 |
| α₃* | 0.96046 | 0.96715 |
| β₁* | 0.08259 | 0.07517 |
| γ₁* | 0.01033 | 0.01043 |
| γ₂* | 0.27089 | 0.25515 |
| γ₃* | 0.00422 | 0.00336 |
| δ₁* | 0.03422 | 0.03133 |
| δ₂* | 0.00739 | 0.00034 |

From Table 1, it is clear that the α₃* lobe displays the strongest correlation with R²=0.96046. It is also interesting to note that the second highest correlation coefficient is associated with the γ₂* lobe, which is adjacent to the α₃* lobe. This suggests that there is indeed a regio-specificity associated with a possible reduction event involved in the mechanism for these compounds. All other lobe correlations displayed R² values less than 0.09. Therefore, the α₃* lobe is the critical lobe/location for the mechanism of action versus P. falciparum. This result also suggests that a reduction event for the tryptanthrin is involved in the mechanism. Training sets for the HOMO of the same molecules were constructed. None of the individual lobe training sets displayed a strong correlation. Thus it would appear that if the HOMO is somehow involved in the mechanism, its part is not rate-limiting.

The correlation observed for the α₃* lobe is logical in that the lower barriers correspond to lower IC₅₀ values, and thus greater efficacies. This is due to the fact that a lower barrier would (presumably) facilitate a more rapid insertion of an electron into the molecule. Also, a coupled effect is that a lower barrier height would typically correspond to a less rapid decay of the electron state into space; thus the MO in this location effective extends further out from the molecule, additionally facilitating a reduction event. Note, however, that this correlation may be observed without any specific information regarding the biological receptor space geometry, electronic properties, or other properties.

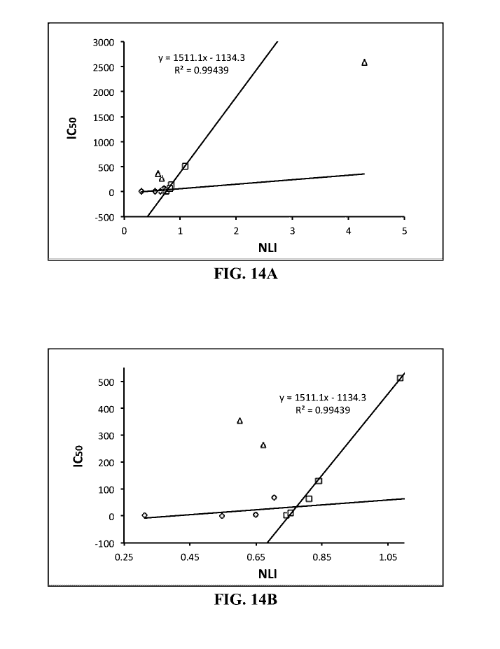

Initially, it may seem that the correlation for the α₃* lobe shown in the plot in FIGS. 13A-13H are in large extent due to the single point with the highest NLI and IC₅₀ (this datum corresponds to the 1,3-diaza-2,4-hydroxy-8-iodotryptanthrin analog). However, while removal of that datum does significantly reduce the observed correlation, the α₃* lobe retains the highest correlation among all of the lobes. Furthermore, upon closer inspection of the data with the 1,3-diaza-2,4-hydroxy-8-iodotryptanthrin datum removed, some interesting behavior is revealed. A plot of these remaining data for the α₃* lobe appears in FIGS. 12A and 12B. Specifically, it appears that there are two regimes within the data set. With the exception of two fliers (FIG. 12B), one regime displays an R² value of ˜0 at lower NLI values and low IC₅₀ values. The other regime shows a linear correlation (R²=0.99) between the IC₅₀ and NLI values. Thus the molecules display a threshold behavior. Once the NLI value is below about 0.80, further reductions in the barrier height energy confer no additional efficacy benefits versus P. falciparum. Thus below this electron tunneling barrier height, the presumed reduction event is no longer rate limiting. This threshold behavior may then serve as a dividing line between likely effective and ineffective anti-malarial candidates. Also of interest in the threshold consideration is the disposition of the 1,3-diaza-2,4-hydroxy-8-iodotryptanthrin datum (FIGS. 14A and 14B). It appears to the right of the line generated by the correlated data from the data subset. This placement would be consistent with a high enough barrier that the molecule either operates via separate mechanism entirely, or that the presumed reduction of the molecule occurs into a different location on the molecule (the γ₂* lobe, which showed the second largest correlation). In addition, the two data points that were not included in the data subset appear above the lines of the two-regime subset. Thus their efficacies are lower than what would be expected by their NLI barrier values. This may be due to other extraneous effects that might lower the efficacies such as poor solubility, or other effect that might limit the compound's bioavailability.

These results provide several important implications regarding the anti-malarial behavior of tryptanthrin compounds. First, the α₃* lobe showed the strongest correlation, even though it didn't display the lowest electron barrier height among the lobes of the LUMO. This is strongly suggestive of a geometrical constraint in the receptor site that requires the participation of (i.e. reduction of the molecule via) the α₃* lobe. Thus the α₃* lobe represents the pharmacopore of tryptanthrins versus P. falciparum. Additionally, if this hypothesis is correct, future lead optimization of tryptanthrins should include a minimization of the barrier associated with the α₃* lobe of the LUMO. In particular, lead optimization candidates should display a NLI below the observed threshold of 0.80.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A method of determining the location on a molecule that is of greatest importance to the activity of that molecule comprising:
identifying and isolating the locations of molecular orbitals on a molecule;
using a mathematical function to model the molecule's electron state interactions with other atoms or molecules;
calculating the decay of each interaction along a specified direction; and
plotting the decay of interaction against the efficacy of the molecule to generate a sub-molecular quantitative structure-activity relationship training set to observe any correlation, wherein the higher correlation corresponds to a molecular orbital location that is critical for the function of that molecule.

2. The method of claim 1 wherein said identifying and isolating the locations of molecular orbitals on a molecule further comprises:
constructing a computer model of the molecular analog to be tested;
calculating multiple iso-values of at least one molecular orbital for said model; and
using said iso-values to construct a three-dimensional matrix for said at least one molecular orbital.

3. The method of claim 1 wherein said mathematical function to model the molecule's electron state interactions with other atoms or molecules further comprises:
using a three-dimensional probe function matrix;
performing a three-dimensional convolution of said probe matrix and said at least one molecular orbital thereby yielding an overlap matrix; and
determining a two-dimensional topography iso-surface in a selected x, y plane from said overlap matrix thereby calculating at least one x,y location.

4. The method of claim 3 wherein said calculating the decay of each interaction along a specified direction further comprises determining a z-direction decay of said overlap matrix for each x,y location of said topography iso-surface.

5. The method of claim 4 wherein said plotting the decay of interaction further comprises:
plotting the decay or topography iso-surface in two dimensions for each x,y location thereby yielding an analytical image comprised of pixels;
locating each molecular orbital lobe in said analytical image and evaluating the pixel quantities associated therewith; and
for each said molecular orbital lobe, plotting the efficacy against evaluated pixel quantities for multiple molecular analogs.

6. A method of determining the location on a molecule that is of greatest importance to the activity of that molecule comprising:
identifying and isolating the locations of molecular orbitals on a molecule;
using a mathematical function to model the molecule's electron state interactions with other atoms or molecules;
calculating the related electron energy barrier of each interaction along a specified direction; and
plotting the related electron energy barrier of said interaction against the efficacy of the molecule to generate a sub-molecular quantitative structure-activity relationship training set to observe any correlation, wherein the higher correlation corresponds to a molecular orbital location that is critical for the function of that molecule.

7. The method of claim 6 wherein said identifying and isolating the locations of molecular orbitals on a molecule further comprises:
constructing a computer model of the molecular analog to be tested;
calculating multiple iso-values of at least one molecular orbital for said model; and
using said iso-values to construct a three-dimensional matrix for said at least one molecular orbital.

8. The method of claim 6 wherein said mathematical function to model the molecule's electron state interactions with other atoms or molecules further comprises:
using a three-dimensional probe function matrix;
performing a three-dimensional convolution of said probe matrix and said at least one molecular orbital thereby yielding an overlap matrix; and
determining a two-dimensional topography iso-surface in a selected x, y plane from said overlap matrix thereby calculating at least one x,y location.

9. The method of claim 8 wherein said calculating the related electron energy barrier of each interaction along a specified direction further comprises determining a z-direction decay of said overlap matrix for each x,y location of said topography iso-surface.

10. The method of claim 9 wherein said plotting the related electron energy barrier of each interaction further comprises:
plotting the decay or topography iso-surface in two dimensions for each x,y location thereby yielding an analytical image comprised of pixels;
locating each molecular orbital lobe in said analytical image and evaluating the pixel quantities associated therewith; and
for each said molecular orbital lobe, plotting the efficacy against evaluated pixel quantities for multiple molecular analogs.

11. A method of determining the active center of a molecule comprising:
constructing a computer model of the molecular analog to be tested;
calculating multiple iso-values of at least one molecular orbital for said model;
using said iso-values to construct a three-dimensional matrix for said at least one molecular orbital;
using a three-dimensional probe function matrix, performing a three-dimensional convolution of said probe matrix and said at least one molecular orbital thereby yielding an overlap matrix;
determine a two-dimensional topography iso-surface in a selected x, y plane from said overlap matrix thereby calculating at least one x,y location;
for each x,y location of said topography iso-surface, determining a z-direction decay of said overlap matrix;
plotting the decay or topography iso-surface in two dimensions for each x,y location thereby yielding an analytical image comprised of pixels;
locating each molecular orbital lobe in said analytical image and evaluating the pixel quantities associated therewith;
for each said molecular orbital lobe, plotting the efficacy against evaluated pixel quantities for multiple molecular analogs thereby yielding a R² value;
evaluating resulting correlations and comparing the R² values on said molecular orbital lobes wherein the highest R² value represents an active center of the molecule.

12. The method of claim 11 wherein said molecular orbitals are calculated using density functional theory or by a Hatree-Fock method.

13. The method of claim 11 wherein said probe function matrix is constructed using at least one of the functions selected from the group consisting of: a spherical Gaussian function a spherical exponential function; an atomic orbital function; a molecular structure function; and a probe molecular orbital function.

14. The method of claim 11 wherein said z-direction decay is determined using at least one of the decay functions selected from the group consisting of: exponential decay function; Gaussian decay function; Lorentzian decay function; polynomial decay function; and linear decay function.

15. The method of claim 11 wherein said pixel quantities are evaluated by at least one method selected from the group consisting of: summing; averaging the median, maximum or minimum over the lobe; individual pixel evaluation; and multiple pixel evaluation.

16. The method of claim 11 wherein efficacy is plotted using at least one of the methods selected from the group consisting of: linear plotting and logarithm plotting.

17. The method of claim 11 wherein regression is performed to evaluate said resulting correlations.

18. The method of claim 17 wherein said regression is calculated using at least one method selected from the group consisting of: least squares regression; linear regression; logarithmic function; and polynomial function.
